(19) United States
(12) Patent Application Publication
(10) Pub. No.: US 2011/0059628 A1
(43) Pub. Date: Mar. 10, 2011

(54) SECURE DIGITAL CARD WITH TWO MICRO-SD CARDS IN STRIPING DATA ACCESS

(75) Inventor: Jen-Kai Chen, Taipei County (TW)

(73) Assignee: SOLID STATE SYSTEM CO., LTD., Hsinchu (TW)

(21) Appl. No.: 12/553,991

(22) Filed: Sep. 4, 2009

(51) Int. Cl. H01R 12/00

(52) U.S. Cl. 439/61

(57) ABSTRACT

The present invention constructs a SD Flash card by plugging two micro-SD cards into a new apparatus that has the same form factor as a SD Flash card. In this new apparatus, there is a controller to bridge the two micro-SD cards of any SD interface speed type (DS, HS, UHS50 or UHS104) to UHS104. The controller performs striping access function to achieve almost double performance in sequential read/write throughput if it is not limited by the target SD interface speed.

### BACKGROUND OF THE INVENTION

1. Field of Invention

The present invention relates to secure digital (SD) card. More particularly, the present invention relates to a SD card by a SD card adaptor with two micro-SD cards in striping data access through an invented controller.

2. Description of Related Art

A flash memory storage card is a portable storage medium, quite popularly used in digital still-image cameras, digital video cameras, mobile phones, or various portable electronic apparatuses. Flash memory storage card has a number of advantages over hard disks, such as being smaller, lighter, portable, silent, power-saving and faster to boot-up.

SD is an acronym for Secure Digital (SD) having 3 kinds of formats: SD, mini-SD, micro-SD. Micro-SD is the smallest memory card available commercially. SD is commonly used in digital still-image cameras, digital video cameras, and portable media players. Micro-SD is commonly used in cellular phones, handheld GPS devices, and expandable USB flash memory drives. In year 2008, it is estimated that micro-SD and SD cards occupy around 80% share of total flash card market. The price of micro-SD cards is down to almost the same price of SD cards of the same capacity.

How to make use the micro-SD more efficiently to achieve the better performance is at least concerned in the present invention.

### SUMMARY OF THE INVENTION

The invention provides a SD card composed of two micro-SD cards, so that the storage capacity and the operation speed can be improved.

The invention provides a secure digital (SD) card adaptor, comprising a plurality of I/O pads, for communicating with an external device. Further, a first adapting structure is included for plugging in a first micro-SD card. A second adapting structure is included for plugging in a second micro-SD card. A controller is included for adapting the first adapting structure and the second adapting structure for data access by the external device via the I/O pads. Wherein, the controller configures a total storing space into a plurality of storage sections for alternatively mapping to the first adapting structure and the second adapting structure.

The invention also provides a secure digital (SD) card, including a containing case, a plurality of I/O pads, a first micro-SD card, a second micro-SD card, and a controller. The I/O pads is for communicating with an external device. The first micro-SD card has a plurality of first storage sections, being embedded or plugged into the containing case. The second micro-SD card has a plurality of second storage sections, being embedded or plugged into the containing case. The controller controls the first micro-SD card and the second micro-SD card to be accessed from the external device via the I/O pads. The controller configures the first storage sections and the second storage sections alternatively into a total storage space.

The invention also provides a method for constructing a secure digital (SD) card with dual micro-SD cards. The method includes providing a SD card adaptor, comprising a first adapting structure, a second adapting structure, and a controller. A first micro-SD card is plugged into the first adapting structure. A second micro-SD card is plugged into the second adapting structure. The controller serves as a bridge in a striping manner for the first micro-SD card and the second micro-SD card to communicate with an external device in data accessing.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a drawing, schematically illustrating a structure of a SD card with dual micro-SD cards, according to an embodiment of the present invention.

FIG. 2 is a drawing, schematically illustrating the controller in FIG. 1, according to an embodiment of the present invention.

FIG. 3 is a drawing, schematically the dimension and mechanical structure of the SD card with dual micro-SD cards, according to an embodiment of the present invention.

FIG. 4 is a drawing, schematically illustrating the data structure in mapping to the two micro-SD cards, according to an embodiment of the present invention.

FIG. 5 is a drawing, schematically the mechanical assembly structure of the SD card with dual micro-SD cards, according to an embodiment of the present invention.

FIG. 6 is a drawing, schematically illustrating the electronic circuit layout of the SD card with dual micro-SD cards, according to an embodiment of the present invention.

### DESCRIPTION OF THE PREFERRED EMBODIMENTS

The present invention bridges two micro-SD cards into a SD card based on a striping mode that performs both capacity aggregation and speed aggregation. Several embodiments are provided for descriptions of the invention but not limit the invention. In addition, the embodiments can be further properly combined into another embodiment.

For an aspect of the invention, the present invention constructs a SD Flash card with two micro-SD cards by a dual micro-SD to SD adaptor. There are 3 kinds of SD memory cards which are classified by storage capacity: (1) Standard Capacity SD Memory Card (SDSC) which is up to and including 2 GB, (2) High Capacity SD Memory Card (SDHC) which is more than 2 GB and up to and including 32 GB, (3) Extended Capacity SD Memory Card (SDXC) which is more than 32 GB and up to and including 2 TB. SD1.0 defines DS (Default Speed) card type up to 25 MHz (12.5 MB/s) 3.3V signaling. SD2.0 defines HS (High Speed) card type up to 50 MHz (25 MB/s) 3.3V signaling. SD3.0 defines 2 new UHS-I (Ultra High Speed Phase I) card types: UHS50 (up to SDR50/DDR50, 100 Mhz 50 MB/s 1.8V signaling) and UHS104 (up to SDR104, 208 Mhz 1.8V signaling). UHS-I is not applied to SDSC card but can be applied to SDHC and SDXC card. The present invention proposes a controller that can be installed on the proposed adaptor of the same form factor as SD to bridge two micro-SD cards of speed type either DS, HS, UHS50 or UHS104 to UHS104. However, the present invention is not limited to these types of SD interface speeds. The controller performs striping access function to achieve almost double throughput performance in sequential read/write for the target SD interface speed. The first example is that two 2 GB micro-SDSC (DS type) cards of 10 MB/s sequential read/write throughput can be bridged to a 4 GB SDHC (HS type) card of 20 MB/s sequential read/write throughput. The second example is that two 8 GB micro-SDHC (HS type) cards of 20 MB/s sequential read and 15 MB/s sequential write throughput can be bridged to either a 16 GB SDHC (UHS104 type) card of 40 MB/s sequential read and 30 MB/s sequential write throughput. The third example is that two 32 GB micro-SDHC (UHS104 type) cards of 60 MB/s sequential read and 35 MB/s sequential write throughput can be bridged to a 64 GB SDXC (UHS104 type) card of 90 MB/s sequential read and 70 MB/s sequential write throughput.

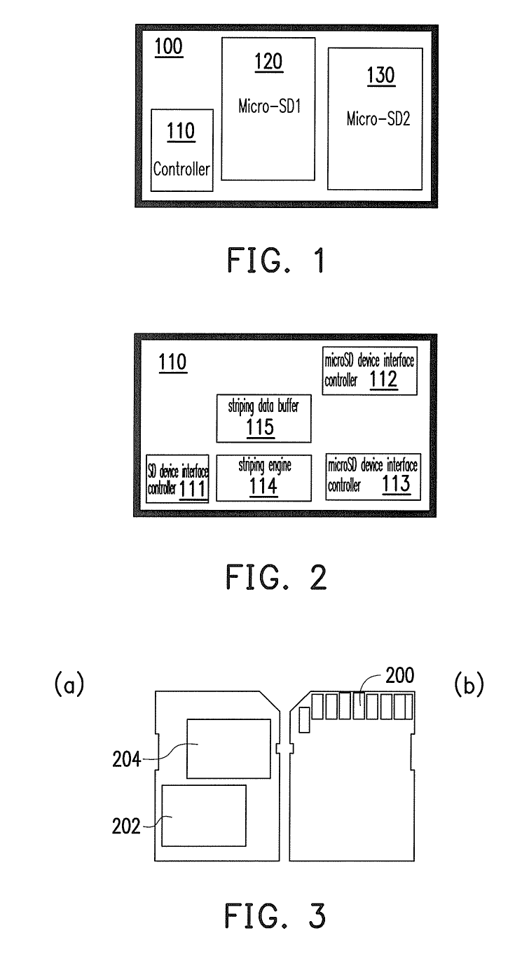

FIG. 1 is a drawing, schematically illustrating a structure of a SD card with dual micro-SD cards, according to an embodiment of the present invention. In FIG. 1, the SD card 100 includes a controller 110, a first micro-SD card 120 and a second micro-SD card 130. The form factor of the SD card 100 in the present invention is same as a normal SD card. However, the storage capacity of the SD card 100 is the sum of the micro-SD cards 120 and 130. The controller 110 is serving as a bridge which combines the two micro-SD cards 120 and 130 as if they are one single memory SD card. In other words, the SD card adaptor can be plugged in with the two micro-SD cards 120 and 130. Here in the example, the two micro-SD cards 120 and 130 are plugged into the adaptor. However, the micro-SD cards 120 and 130 can also be directly embedded in the adaptor without changing the operation mechanism as described in the following description. The controller 110 implemented on the adaptor can combine the two micro-SD cards 120 and 130 into a single memory space. The controller 110 configures storage sections of the first and second micro-SD cards 120 and 130.

FIG. 2 is a drawing, schematically illustrating the controller in FIG. 1, according to an embodiment of the present invention. In FIG. 2, the controller 110 includes a first control unit 111, such as SD device interface controller, a second control unit 112, such as micro SD device interface controller, a third control unit 113, such as another micro SD device interface controller. In addition, a striping engine 114 and a buffer unit 115, such as striping data buffer are included in the controller 110. The first control unit 111 serves as an interface between an external device, such as a host of digital camera et al. (not shown in the drawing) and the two micro-SD cards 120 and 130 for communication. The second controller 112 is in association with the first control unit 111 for accessing the first micro-SD card 120. The third controller 113 is in association with the first control unit 111 for accessing the second micro-SD card 130. The buffer unit 115 is for buffering data being accessed by the external device. The striping engine 114 is for mapping the total storage space with the first storage sections and the second storage sections. In other words, the controller 110 can bridge the two micro-SD cards 120 and 130 into a single SD card 100, which is recognized as a single SD card by the external device.

FIG. 3 is a drawing, schematically the dimension and mechanical structure of the SD card with dual micro-SD cards, according to an embodiment of the present invention. In FIG. 3, the case of the SD card 100 can be in the dimension as a standard size of a SD card, formed by two covers. For example in FIG. 3(a), the SD card carries the two micro-SD cards 202 and 204. The cover in FIG. 3(b) exposes the I/O terminals 200 according the usual specification of the SD card.

Alternatively, before the micro-SD cards are plugged in, the SD case is like a SD card adaptor, including a plurality of I/O pads, for communicating with an external device. In addition, a first adapting structure is included for plugging an external first micro-SD card. A second adapting structure is included for plugging an external second micro-SD card. A controller is included for connecting the first adapting structure and the second adapting structure so as to a data accesses from the external device by the I/O pads. Wherein, the controller configures a total storing space into a plurality of storage sections for alternatively mapping to the first adapting structure and the second adapting structure.

In considering the dimension of the dual microSD to SD adaptor and the micro-SD card, because the SD dimension is 32 mm×24 mm×2.1 mm and the micro-SD dimension is 15 mm×11 mm×1.0 mm, it is feasible for a SD adaptor to contain two micro-SD cards and a striping controller.

Two 8 GB microSDHC (HS mode) cards of 20 MB/s sequential read and 15 MB/s sequential write throughput can be bridged to a 16 GB SDHC (HS mode) card of 20 MB/s sequential read/write throughput. By jump option of, for example, “UHS104 mode”, the two 8 GB microSD cards can be bridged to a 16 GB SDHC (UHS104 mode) card of 40 MB/s sequential read and 30 MB/s sequential write throughput.

By the SD3.0 standard specification, UHS-I mode can be applied to SDHC card. The present invention can upgrade the two microSDHC cards of HS mode to a SDHC card of UHS104 mode to get double performance, compared with the normal single micro-SD to SD adaptor.

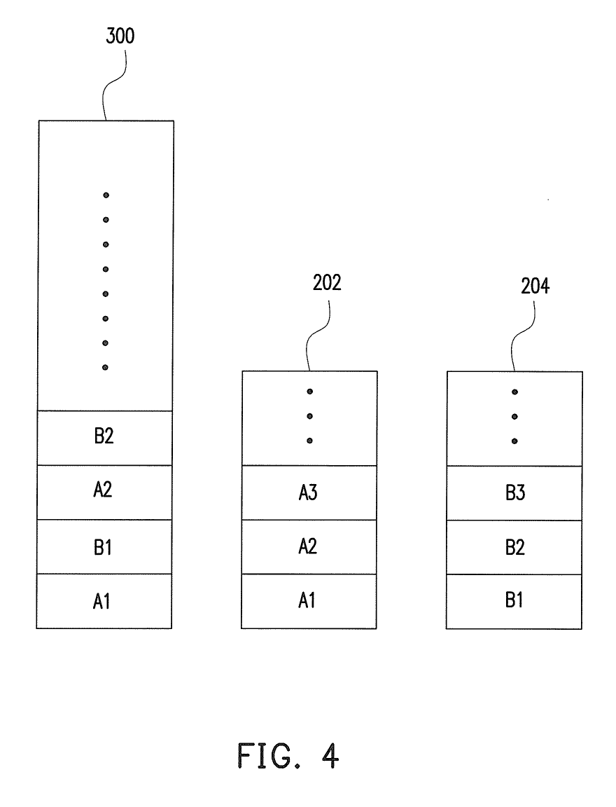

From the data structure, the storage space can be configured to alternatively distribute to the two micro-SD card. FIG. 4 is a drawing, schematically illustrating the data structure in mapping to the two micro-SD cards, according to an embodiment of the present invention.

In FIG. 4, the total storage space 300, recognized by the external device, can be provided in the SD card with dual micro-SD cards. The storage space 300 can be configured into a plurality of storage sections in A1, B1, A2, B2, A3, B3, . . . etc. The micro-SD card 202 is also configured into storage sections in A1, A2, A3, . . . , etc. The micro-SD card 204 is also configured into storage sections in B1, B2, B3, . . . , etc. As a result, the storage sections in the storage space 300, recognized by the external device, are alternatively mapped to micro-SD card 202 and micro-SD card 204.

Further in example, the buffer unit 115 can be used to respectively buffer the data to be written to the micro-SD cards 202 and 204. This also indicated that the two micro-SD cards 202 and 204 can be written in a parallel manner.

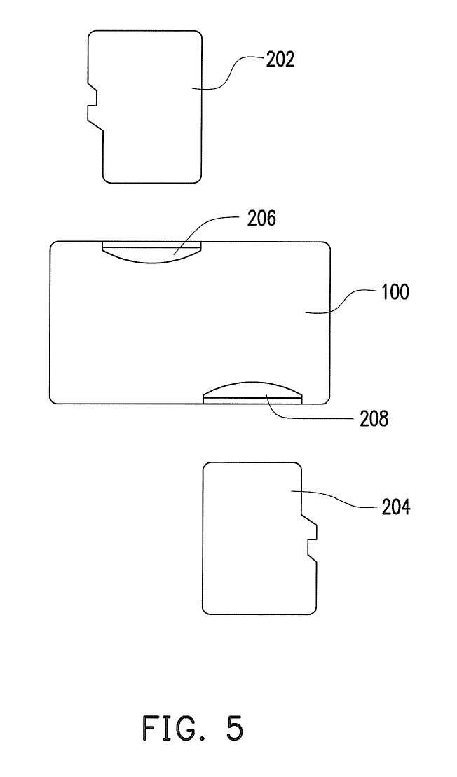

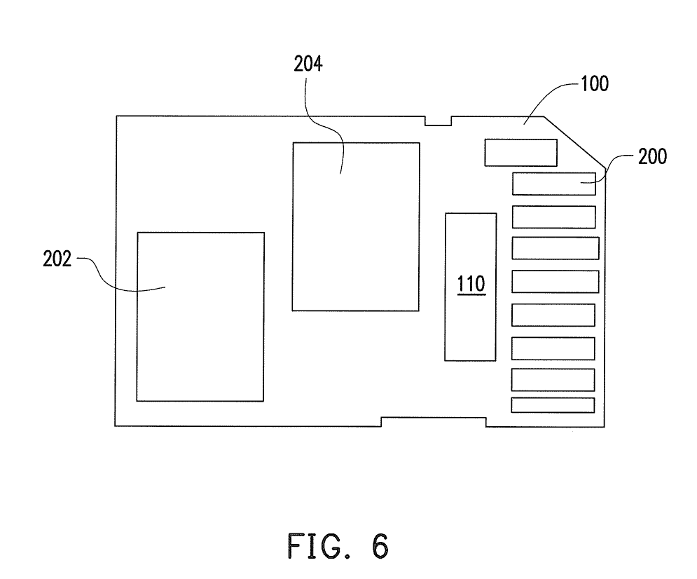

FIG. 5 is a drawing, schematically the mechanical assembly structure of the SD card with dual micro-SD cards, according to an embodiment of the present invention. In FIG. 5, the mechanical assembly structure of the SD card 100 includes a secure digital (SD) card adaptor and two micro-SD cards 202 and 204. The SD card adaptor has a plurality of I/O pads 200, shown in FIGS. 3 and 6, for communicating with an external device. The SD card adaptor includes a first adapting structure 206 for plugging a micro-SD card 202. The SD card adaptor also includes a second adapting structure 208 for plugging another micro-SD card 204. After the two micro-SD cards 202, 204 are plugged into the adapting structures 206, 208, the SD card with dual micro-SD cards is formed and treated as a single SD card in actual use. The adapting structures 206, 208 include the insert holes for containing the micro-SD card and the interconnect structure for connection to the controller. The SD card adaptor 100 can also have no the adapting structures 206 and 208 in the case of that the two micro-SD cards 202 and 204 are installed in a non-removable manner into the case of SD card adaptor.

FIG. 6 is a drawing, schematically the electronic circuit layout of the SD card with dual micro-SD cards, according to an embodiment of the present invention. In FIG. 6, after plugging the two micro-SD cards, 202, 204, they are fixed in the inner space. The SD-card adaptor also has the I/O pads 200 for connecting with the external device for data communication. A controller 110 is implemented in the SD-card adaptor for connecting the first adapting structure 206 and the second adapting structure 208 so as to have a data accesses from the external device by the I/O pads 200. The controller 110 configures a total storing space into a plurality of storage sections for alternatively mapping to the first adapting structure 204 and the second adapting structure 208 when the micro-SD cards are plugged in.

From the aspect in construction the SD card with dual micro-SD cards, the invention for example provides a method for constructing a secure digital (SD) card with dual micro-SD cards. The method includes providing a SD card adaptor, comprising a first adapting structure, a second adapting structure, and a controller. A first micro-SD card is plugged into the first adapting structure. A second micro-SD card is plugged into the second adapting structure. The controller serves as a bridge for the two micro-SD card and the second micro-SD card to communicate with an external device in data accessing.

For the more embodiments in various modifications for better detail, The SD card adaptor is configured based on striping manner. The size of each of the storage sections is a chunk size determined by the striping engine.

Further, if just one micro-SD card is in use, the operation still remains as shown in FIG. 4 but ignore the space in A1, A2, A3. . . , etc., or B1, B2, B3 . . . etc. This is just a choice without changing the configuration of the present invention.

For the further embodiments, for example, the controller can automatically recognize the plugged two micro-SD cards and achieving an operation speed for accessing the two micro-storage cards. The two micro-SD cards may have the same operation speed or different operations speeds.

For the further embodiments, for example, the first micro-SD card and the second micro-SD card have a same storage capacity or different storage capacities.

For the further embodiments, for example, the first micro-SD card and the second micro-SD card are in a same spec-type or different spec-types.

For the further embodiments, for example, each of the micro-SD cards has a SD interface speed type, such as DS, HS, UHS50 or UHS104.

For the further embodiments, for example, the first micro-SD card and the second micro-SD card are operated at the same SD interface speed.

For the further embodiments, for example, the first micro-SD card and the second micro-SD card are operated at different SD interface speeds.

For the further embodiments, for example, the first micro-SD card and the second micro-SD card are parallel in internal access operation.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A secure digital (SD) card adaptor, comprising:
a plurality of I/O pads, for communicating with an external device;
a first adapting structure, for plugging in a first micro-SD card;
a second adapting structure, for plugging in a second micro-SD card; and
a controller, for adapting the first adapting structure and the second adapting structure for data access by the external device via the I/O pads,
wherein, the controller configures a total storing space into a plurality of storage sections for alternatively mapping to the first adapting structure and the second adapting structure.

2. The secure digital (SD) card adaptor of claim 1, wherein the controller comprises:
a first interface control unit, for communicating with the external device;
a second interface control unit, for communicating with the first adapting structure;
a third interface control unit, for communicating with the second adapting structure;
a buffer unit, for buffering the data being accessed by the external device; and
a striping engine, for distributing the storage sections to the first second adapting structure and the second adapting structure.

3. The secure digital (SD) card adaptor of claim 1, wherein a size of each of the storage sections is a chunk size which is determined by the striping engine.

4. The secure digital (SD) card adaptor of claim 1, wherein only one of the first adapting structure and the second adapting structure is in use.

5. The secure digital (SD) card adaptor of claim 1, wherein the first adapting structure and the second adapting structure are all in use.

6. A secure digital (SD) card, comprising:
a containing case;
a plurality of I/O pads, for communicating with an external device;
a first micro-SD card, having a plurality of first storage sections, being embedded or plugged into the containing case;
a second micro-SD card, having a plurality of second storage sections, being embedded or plugged into the containing case; and
a controller, for controlling the first micro-SD card and the second micro-SD card to be accessed from the external device via the I/O pads,
wherein, the controller configures the first storage sections and the second storage sections alternatively into a total storage space.

7. The secure digital (SD) card of claim 6, wherein the controller comprises:
a first control unit, serving as an communication interface between the external device and the two micro-SD cards;
a second interface control unit, for accessing the first micro-SD card;
a third interface control unit, for accessing the second micro-SD card;
a buffer unit, for buffering the data being accessed by the external device; and
a striping engine, for mapping the total storage space with the first storage sections and the second storage sections.

8. The secure digital (SD) card of claim 7, wherein a size of each of the first storage sections and the second storage section is a chunk size which is determined by the striping engine.

9. The secure digital (SD) card of claim 6, wherein the controller automatically recognizes the plugged two micro-SD cards and achieving an operation speed for accessing the two micro-storage cards.

10. The secure digital (SD) card of claim 6, wherein the first micro-SD card and the second micro-SD card have a same operation speed or different operations speeds.

11. The secure digital (SD) card of claim 6, wherein the first micro-SD card and the second micro-SD card have a same storage capacity or different storage capacities.

12. The secure digital (SD) card of claim 6, wherein the first micro-SD card and the second micro-SD card are in a same spec-type or different spec-types.

13. The secure digital (SD) card of claim 6, wherein the first micro-SD card has a SD interface speed being one selected from the types consisting of DS, HS, UHS50 or UHS104; and the second micro-SD card has a SD interface speed being one selected from the types consisting of DS, HS, UHS50 or UHS104.

14. The secure digital (SD) card of claim 13, wherein the first micro-SD card and the second micro-SD card are operated at the same SD interface speed.

15. The secure digital (SD) card of claim 13, wherein the first micro-SD card and the second micro-SD card are operated at different SD interface speeds.

16. The secure digital (SD) card of claim 13, wherein the first micro-SD card and the second micro-SD card are parallel in internal access operation.

17. A method for constructing a secure digital (SD) card with dual micro-SD cards, comprising:
providing a SD card adaptor, comprising a first adapting structure, a second adapting structure, and a controller;
plugging a first micro-SD card into the first adapting structure; and
plugging a second micro-SD card into the second adapting structure,
wherein the controller serves as a bridge for the two micro-SD card and the second micro-SD card to communicate with an external device in data accessing.
